(19) United States
(12) Patent Application Publication
(10) Pub. No.: US 2016/0078376 A1
(43) Pub. Date: Mar. 17, 2016

(54) INFORMATION PROCESSING APPARATUS, NON-TRANSITORY COMPUTER READABLE MEDIUM, AND INFORMATION PROCESSING METHOD

(71) Applicant: FUJI XEROX CO., LTD., Tokyo (JP)

(72) Inventor: Naoki HAYASHI, Kanagawa (JP)

(21) Appl. No.: 14/609,016

(22) Filed: Jan. 29, 2015

(30) Foreign Application Priority Data
Sep. 17, 2014 (JP) 2014-188524

(51) Int. Cl. G06Q 10/06; G06Q 10/10

(52) U.S. Cl. CPC G06Q 10/0635; G06Q 10/10

(57) ABSTRACT

An information processing apparatus includes an instructing unit that, if a deficiency in a first organization is discovered by implementation of a control in the first organization, instructs a second organization to implement the control implemented in the first organization, the second organization having a risk equivalent to a risk corresponding to the control and adopting a control that is not equivalent to the control.

### CROSS-REFERENCE TO RELATED APPLICATIONS

This application is based on and claims priority under 35 USC 119 from Japanese Patent Application No. 2014-188524 filed Sep. 17, 2014.

### BACKGROUND

### Technical Field

The present invention relates to an information processing apparatus, a non-transitory computer readable medium, and an information processing method.

### SUMMARY

According to an aspect of the invention, there is provided an information processing apparatus including an instructing unit that, if a deficiency in a first organization is discovered by implementation of a control in the first organization, instructs a second organization to implement the control implemented in the first organization, the second organization having a risk equivalent to a risk corresponding to the control and adopting a control that is not equivalent to the control.

### BRIEF DESCRIPTION OF THE DRAWINGS

Exemplary embodiment of the present invention will be described in detail based on the following figures, wherein:

FIG. 1 is a conceptual module diagram of an exemplary configuration according to the exemplary embodiment;

FIG. 2 illustrates an exemplary system configuration for implementing the exemplary embodiment;

FIG. 3 illustrates an exemplary system configuration for implementing the exemplary embodiment;

FIG. 4 is a flowchart illustrating exemplary processing according to the exemplary embodiment;

FIG. 5 is a flowchart illustrating exemplary processing according to the exemplary embodiment;

FIG. 6 illustrates an exemplary data structure of a target control/alternative control correspondence table;

FIG. 7 is a flowchart illustrating exemplary processing according to the exemplary embodiment;

FIG. 8 illustrates an exemplary data structure of a control/stringency correspondence table; and

FIG. 9 is a block diagram illustrating an exemplary hardware configuration of a computer that implements the exemplary embodiment.

### DETAILED DESCRIPTION

Hereinafter, an exemplary embodiment of the invention will be described with reference to the drawings.

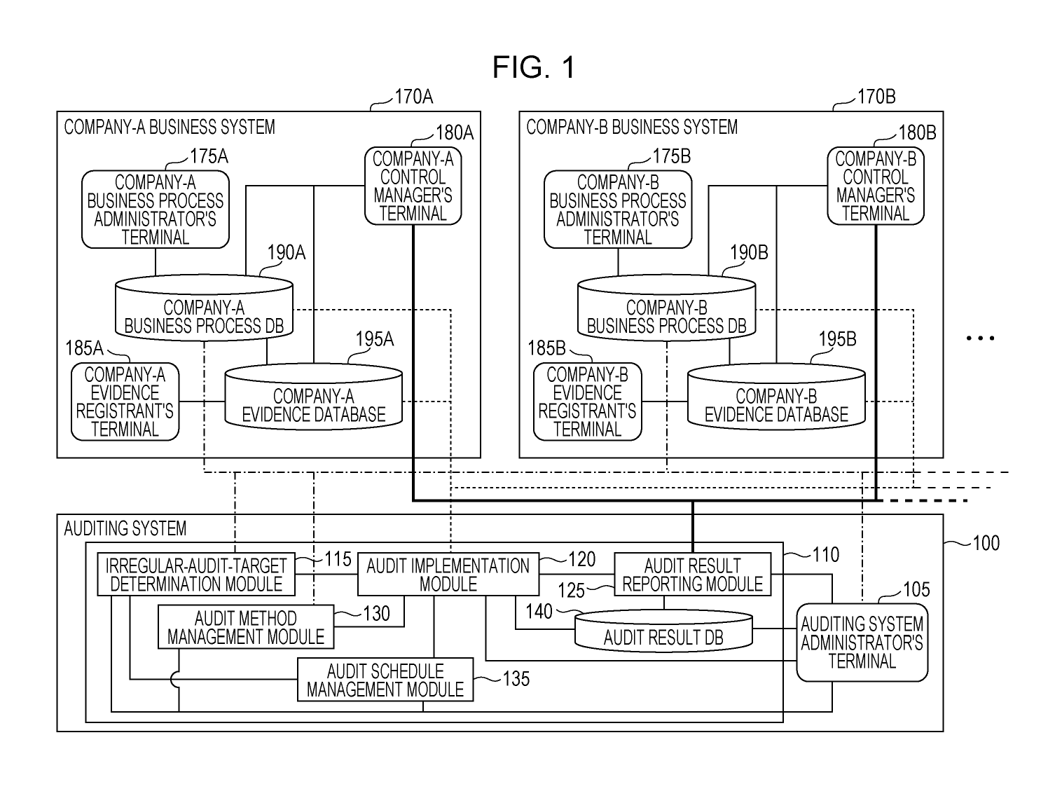

FIG. 1 is a conceptual module diagram of an exemplary configuration according to the exemplary embodiment.

The term “module” generally refers to a logically separable component of software (computer program), hardware, or the like. Therefore, the term “module” as used in the exemplary embodiment refers to not only a module in a computer program but also a module in a hardware configuration. Thus, the exemplary embodiment will be also described in the context of a computer program for providing functions of modules (a program for causing a computer to execute individual procedures, a program for causing a computer to function as individual units, and a program for causing a computer to realize individual functions), a system, and a method. While “store”, “be stored”, and equivalent expressions are used herein for the convenience of description, these expressions mean, when an exemplary embodiment relates to a computer program, “cause a memory to store” or “perform control so as to cause a memory to store.” While individual modules and functions may have a one-to-one correspondence, in actual implementation, a single module may be implemented by a single program, or multiple modules may be implemented by a single program. Conversely, a single module may be implemented by multiple programs. Further, multiple modules may be executed by a single computer, or a single module may be executed by multiple computers that are in a distributed or parallel environment. A single module may include another module. In the following description, the term “connection” refers to not only a physical connection but also a logical connection (such as exchanging of data, issuing of an instruction, and cross-reference between data items). The term “predetermined” as used herein means being determined prior to a process of interest, which not only means being determined before processing according to the exemplary embodiment begins but also being determined, even after the processing according to the exemplary embodiment begins, at any point in time preceding a process of interest in accordance with the condition/state at that point in time, or in accordance with the condition/state up to that point in time. If multiple “predetermined values” exist, each of these values may be different, or two or more of these values may be the same (which includes, of course, cases where all of these values are the same). Further, expressions that have the meaning of “if A, then B” is used to mean that “it is determined whether A, and then B if it is determined that A”, unless it is not required to determine whether A.

Furthermore, the term “system” or “apparatus” includes not only cases where a system or apparatus is made up of multiple computers, hardware components, devices, or the like that are connected to each other via a communication medium such as a network (including a one-to-one communication setup), but also cases where a system or apparatus is implemented by a single computer, hardware component, or device. The terms “apparatus” and “system” are herein used synonymously. As a matter of course, the term “system” does not include what is merely a social “mechanism” (social system) which is a man-made arrangement of rules.

Further, for each process executed by each module or, if multiple processes are to be executed within a module, for each of the multiple processes, information of interest is read from a memory, and after implementation of the corresponding process, the results of processing are written into the memory. Therefore, a description about reading of information from a memory prior to a process, or writing of information into a memory after a process will sometimes be omitted. The term “memory” as used herein may include a hard disk, a random access memory (RAM), an external storage medium, a memory using a communication line, and a register in a central processing unit (CPU).

The exemplary embodiment assigns controls appropriate to individual risks that can arise in an organization, in evaluations as prescribed by the International Organization for Standardization ((ISO), more specifically, ISO27001 or the like), Information Security Management System (ISMS), or the like.

To implement internal control, it is necessary to create a risk control matrix (RCM) or the like as a basic document. An RCM is a table that summarizes, for internal control activities related to business processes in an organization, control points (assertions) to be accomplished, expected risks, and corresponding internal control activities. An assertion is a precondition for being able to assert that financial information is reliable. Specifically, the following six items: existence, completeness, valuation, rights and obligations, period/allocation, and presentation are generally used, although these are often partially modified by individual companies and auditing corporations and thus may be customized. A risk refers to a factor that can impede achievement of an organization's objectives, specifically, an impediment to an assertion which is expected in a business process. A control refers to an internal control activity designed to mitigate a risk. Types of controls include preventive and detective. An organization is an entity to which internal control is applied, examples of which include a corporation, a company, and a department. In the following, a company will be described as an example of an organization. The term “sampling (number)”, which is a term used in evaluation of a control (operations test (to be also referred to simply as “test” hereinafter)), refers to a procedure that uses results obtained from examination of a subset of items to evaluate the characteristics of the whole set. A population refers to the whole aggregate from which test subjects for sampling are extracted by random sampling. Evidence refers to a trace that may serve as proof.

An auditing system 100 according to the exemplary embodiment implements an audit as internal control. As illustrated in FIG. 1, the auditing system 100 has an auditing system administrator's terminal 105, and an information processing apparatus 110. The information processing apparatus 110 has an irregular-audit-target determination module 115, an audit implementation module 120, an audit result reporting module 125, an audit method management module 130, an audit schedule management module 135, and an audit result DB 140.

The auditing system 100 is used from a Company-A business system 170A and a Company-B business system 170B that are connected to the auditing system 100 via a communication line. The auditing system 100 performs, for example, an auditing service having an irregular audit function that is triggered by discovery of a deficiency. That is, the auditing system 100 implements an irregular audit whereby if a deficiency in a given organization is discovered by implementation of a control in the organization, the control implemented in the organization is applied to another company.

While the following description will be directed to a case where the target organization to be audited is Company A, Company B, or the like, the target organization may be any entity for which an audit is performed, and may be an organization other than a company. For example, the organization may be a department or the like within a company. Further, Company A and Company B may have an affiliate relationship or the like, or may be independent organizations that are not related to each other.

The Company-A business system 170A has a Company-A business process administrator's terminal 175A, a Company-A control manager's terminal 180A, a company-A evidence registrant's terminal 185A, a Company-A business process DB 190A, and a Company-A evidence DB 195A. The Company-B business system 170B has a Company-B business process administrator's terminal 175B, a Company-B control manager's terminal 180B, a company-B evidence registrant's terminal 185B, a Company-B business process DB 190B, and a Company-B evidence DB 195B. Although the Company-A business system 170A and the Company-B business system 170B are equivalent to each other in system configuration, the Company-A business system 170A and the Company-B business system 170B may not necessarily be completely identical but may only need to have equivalent functions in relation to the auditing system 100.

The business process DB 190 is connected to the business process administrator's terminal 175, the control manager's terminal 180, the evidence DB 195, and the auditing system administrator's terminal 105, and to the irregular-audit-target determination module 115, the audit implementation module 120, and the audit method management module 130 of the information processing apparatus 110. The business process DB 190 holds information about a process to execute business, a risk that arises in the process, and a control for preventing the risk from manifesting itself. The business process DB 190 may further holds information about the executor or approver of the process, and the executor or approver of the control.

The business process administrator's terminal 175 is connected to the business process DB 190. The business process administrator's terminal 175 is a terminal used by a business process administrator authorized to register, edit, or delete data in the business process DB 190 to perform these operations.

The evidence DB 195 is connected to the control manager's terminal 180, the evidence registrant's terminal 185, the business process DB 190, and the audit implementation module 120 of the information processing apparatus 110. The evidence DB 195 holds evidence of execution of controls.

The evidence registrant's terminal 185 is connected to the evidence DB 195. The evidence registrant's terminal 185 is a terminal used by an evidence registrant authorized to register evidence in the evidence DB 195 to perform a registration process.

The control manager's terminal 180 is connected to the business process DB 190 and the evidence DB 195, and to the audit result reporting module 125 of the information processing apparatus 110. The control manager's terminal 180 is the terminal of the control manager for business processes. The control manager's terminal 180 displays information held by the business process DB 190 and the evidence DB 195, thus allowing the status of control to be checked. The control manager's terminal 180 is also able to display a report sent from the auditing system 100 described later.

The audit schedule management module 135 is connected to the auditing system administrator's terminal 105, the irregular-audit-target determination module 115, and the audit implementation module 120. The audit schedule management module 135, which holds the audit schedule of each company, has the function of causing the audit implementation module 120 described later to implement an audit in accordance with the schedule.

A schedule of a regular audit is, for example, registered, edited, or deleted in response to operation by the auditing system administrator via the auditing system administrator's terminal 105 described later. A schedule of an irregular audit is registered by the irregular-audit-target determination module 115 described later.

According to this function, one audit schedule is represented as one set of the following attributes.
Schedule ID is data for uniquely identifying each audit schedule within the auditing system 100.
Target Company is data indicative of the company to be audited.
Start Date and Time is data indicative of the date and time to start an audit.
Finish Date and Time is data indicative of the date and time when an audit is finished.
Implementation Status indicates the status of implementation of an audit. Implementation Status has a value indicating one of the followings: “Not Started”, “In Progress”, and “Completed.”
Audit Type indicates the type of an audit. Audit Type has a value indicating one of “Regular” and “Irregular.”
Target Control is data indicative of the control to be audited. In the exemplary embodiment, Target Control takes a single value (that is, one control is audited during one audit schedule).
Alternative Control is set when the audit type is “Irregular.” Alternative Control is data indicating a control by which the target control is to be replaced. In the exemplary embodiment, Alternative Control takes a single value (that is, one control is audited during one audit schedule).
Audit Method is data indicative of the method of auditing a control. An audit method ID managed by the audit method management module 130 described later is set as an attribute value.

The audit method management module 130 is connected to the auditing system administrator's terminal 105, the audit implementation module 120, the Company-A business process DB 190A of the Company-A business system 170A, and the Company-B business process DB 190B of the Company-B business system 170B. The audit method management module 130 has the function of managing how to perform an audit for a control by using evidence. The audit method is, for example, registered, edited, or deleted in response to operation by the auditing system administrator via the auditing system administrator's terminal 105 described later.

The audit implementation module 120 is connected to the auditing system administrator's terminal 105, the irregular-audit-target determination module 115, the audit result reporting module 125, the audit method management module 130, the audit schedule management module 135, the audit result DB 140, the Company-A business process DB 190A and the Company-A evidence DB 195A of the Company-A business system 170A, and the Company-B business process DB 190B and the Company-B evidence DB 195B of the Company-B business system 170B. The audit implementation module 120 detects that a deficiency in Company A is discovered by implementation of a control in Company A, from information transmitted from the Company-A business system 170A. Then, when the audit implementation module 120 detects that a deficiency is discovered, if Company B has a risk equivalent to a risk corresponding to the control implemented in Company A, and a control n Company B which corresponds to this risk is not equivalent to the control implemented in Company A, the audit implementation module 120 instructs the Company-B business system 170B of Company B to implement, in Company B, the control implemented in Company A. In Company B, an irregular audit is implemented from a different point of view, and a problem that may not have been previously recognized by Company B is found.

The term “equivalent risk” includes, of course, the completely identical risk, and also includes a similar risk. Whether a risk is similar to another may be determined as follows. That is, a table defining risks that are similar to each other is prepared in advance, and this table is used to make this determination. The term “equivalent control” includes, of course, the completely identical control, and also includes a similar control. Whether a control is similar to another may be determined as follows. That is, a table defining controls that are similar to each other is prepared in advance, and this table is used to make this determination.

Further, if a control corresponding to a risk which is implemented in Company A is more stringent than a control corresponding to the control which is adopted in Company B, the audit implementation module 120 may instruct the Company-B business system 170B to implement, in Company B, the control implemented in Company A.

A more detailed description is given below.

The audit implementation module 120 implements an audit of each company in accordance with one audit schedule held in the audit schedule management module 135, by using business process information and evidence information about each company, and the audit method held in the audit method management module 130. As for the method of “implementing an audit” at this time, an audit may be implemented by using a computer program (script), or if a computer program is not prepared, a notification (an email or the like) may be given to the control manager of the target organization to inform that an audit is to be implemented.

A. Case where the audit type of an audit schedule is “Regular”: An audit is implemented by applying an audit method to the target control existing in a business process of the target company. If a deficiency in the target company is discovered by implementation of the control by a regular audit, the irregular-audit-target determination module 115 is caused to determine a company and a control for which an irregular audit is to be performed.

B. Case where the audit type of an audit schedule is “Irregular”: Control in which the target control existing in a business process of the target company is replaced by an alternative control is executed or simulated by using business process information and evidence information about the target company, and an audit is implemented by applying an audit method to the obtained result.

The irregular-audit-target determination module 115 is connected to the auditing system administrator's terminal 105, the audit implementation module 120, the audit schedule management module 135, the Company-A business process DB 190A of the Company-A business system 170A, and the Company-B business process DB 190B of the Company-B business system 170B.

The irregular-audit-target determination module 115 has the function of determining a control in another company for which an irregular audit is to be performed, when a deficiency in a given company is discovered by implementation of a control during a regular audit of the company.

In the exemplary embodiment, it is determined to perform an irregular audit in a case where the following conditions are met in a given company, Company Y:

1. There exists the same risk as the risk that is attempted to be addressed by a control Cx in Company X in which a deficiency is discovered.

2. It is attempted to address the risk by a control Cy different from Cx.

If an irregular audit target is found, an audit schedule is registered in the audit schedule management module 135 as follows.
Target Company: Company Y
Start Date and Time: <The date and time when the system is able to immediately execute the audit>
Audit Type: “Irregular”
Target Control: Cy
Alternative Control: Cx

The audit implementation module 120 implements the audit in accordance with the above registered information.

The audit result DB 140 is connected to the auditing system administrator's terminal 105, the audit implementation module 120, and the audit result reporting module 125. The audit result DB 140 has the function of holding the result of an audit for each company implemented by the audit implementation module 120. The audit result is held in association with a schedule ID. If a new audit result is registered, the audit result reporting module 125 is notified of the newly registered audit result.

The audit result reporting module 125 is connected to the auditing system administrator's terminal 105, the audit implementation module 120, the audit result DB 140, the Company-A control manager's terminal 180A of the Company-A business system 170A, and the Company-B control manager's terminal 180B of the Company-B business system 170B. If the audit implementation module 120 detects that a deficiency in an organization is discovered by implementation of a control, the audit result reporting module 125 discloses the control that has discovered the deficiency (the control by which the deficiency is discovered in Company A), at least to organizations other than Company A (for example, to the Company-B business system 170B of Company B). The “organizations other than Company A” may be at least one organization.

A more detailed description is given below.

The audit result reporting module 125 has the function of reporting, to the control manager of the company that has been audited, the result of the audit of the company. Examples of the audit result include the result of a regular audit, and the result of an irregular audit. Reporting of the result is implemented with notification from the audit result DB 140 as a trigger. Upon receiving the reported result, the control manager of each company may consider an alternative control and its effect.

The auditing system administrator's terminal 105 is connected to the irregular-audit-target determination module 115, the audit implementation module 120, the audit result reporting module 125, the audit method management module 130, the audit schedule management module 135, the audit result DB 140, the Company-A business process DB 190A of the Company-A business system 170A, and the Company-B business process DB 190B of the Company-B business system 170B. The auditing system administrator's terminal 105 is a terminal for the administrator of the auditing system. The auditing system administrator's terminal 105 has a function that makes it possible to check, for example, settings on various functions mentioned above and the processing status.

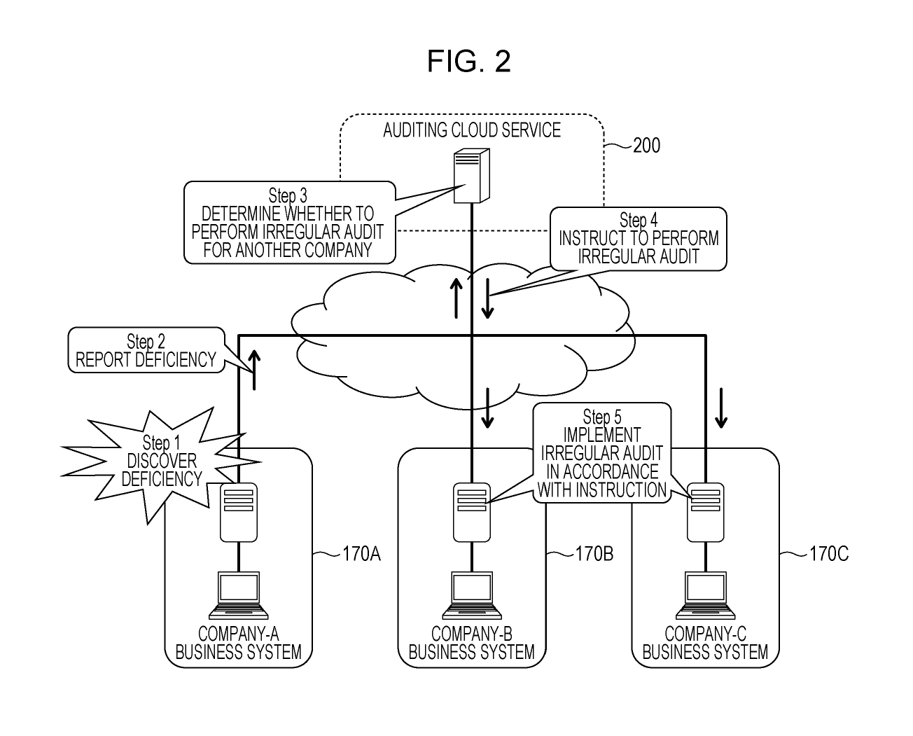

FIG. 2 illustrates an exemplary system configuration for implementing the exemplary embodiment.

FIG. 2 illustrates a case where the auditing system 100 illustrated in FIG. 1 is implemented as an auditing cloud service 200. The auditing cloud service 200, the Company-A business system 170A, the Company-B business system 170B, and a Company-C business system 170C are connected to each other via a communication line 290. The communication line 290 may be a wireless line, a wired line, or a combination thereof. For example, the communication line 290 may be an intranet or the Internet serving as a communication infrastructure.

The following conditions are assumed. For example, there are cases where individual companies (the Company-A business system 170A, the Company-B business system 170B, and the Company-C business system 170C) apply different controls to the same risk. The auditing cloud service 200 regards controls applied to the same risk as irregular audit candidates. For example, similar controls may be excluded from these candidates.

FIG. 2 illustrates a case where an audit is performed on an irregular basis, by applying a control in Company A in which a deficiency is discovered to another company.

In Step1, a deficiency is discovered in the Company-A business system 170A.

In Step2, the Company-A business system 170A reports the deficiency to the auditing cloud service 200.

In Step3, the auditing cloud service 200 determines whether to perform an irregular audit for another company.

In Step4, the auditing cloud service 200 instructs the Company-B business system 170B and the Company-C business system 170C, which are determined as the targets of an audit, to perform an irregular audit.

In Step5, each of the Company-B business system 170B and the Company-C business system 170C implements an irregular audit in accordance with the instruction.

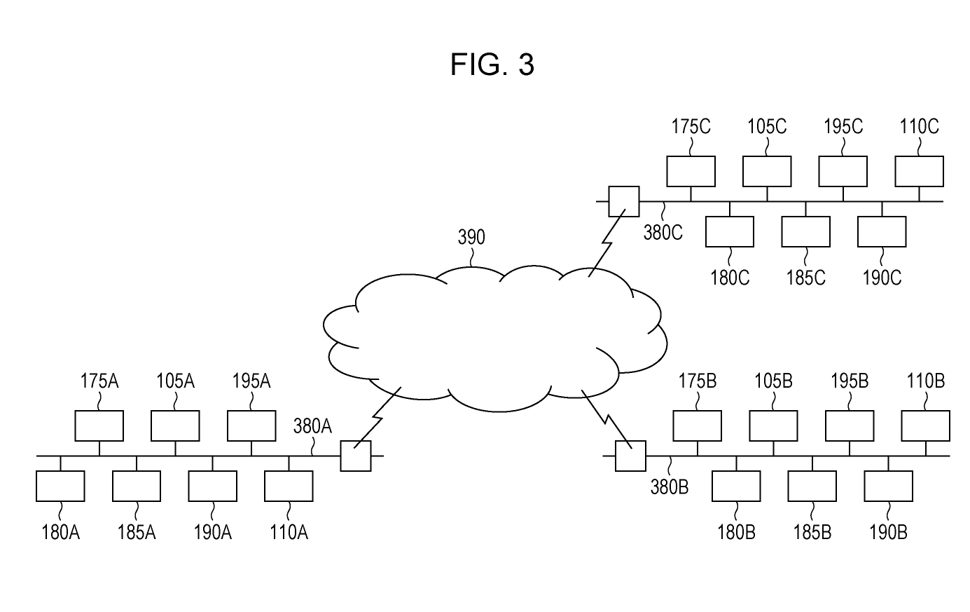

FIG. 3 illustrates an exemplary system configuration for implementing the exemplary embodiment. In the exemplary system configuration illustrated in FIG. 2, the auditing system 100 is implemented as the auditing cloud service 200. However, it is also possible to adopt a system configuration in which each company has its own information processing apparatus 110, and the information processing apparatuses 110 of individual companies communicate with each other to instruct another information processing apparatus 110 (or the auditing system administrator's terminal 105) to perform an irregular audit.

In each company, the auditing system administrator's terminal 105, the information processing apparatus 110, the business process administrator's terminal 175, the control manager's terminal 180, the evidence registrant's terminal 185, the business process DB 190, and the evidence DB 195 are connected to each other via an intra-company communication line 380. The intra-company communication line 380 may be a wireless line, a wired line, or a combination thereof. For example, the intra-company communication line 380 may be the Internet serving as a communication infrastructure.

An intra-company communication line 380A, an intra-company communication line 380B, and an intra-company communication line 380C are connected to each other via a communication line 390. The communication line 390 may be a wireless line, a wired line, or a combination thereof. For example, the communication line 390 may be the Internet serving as a communication infrastructure.

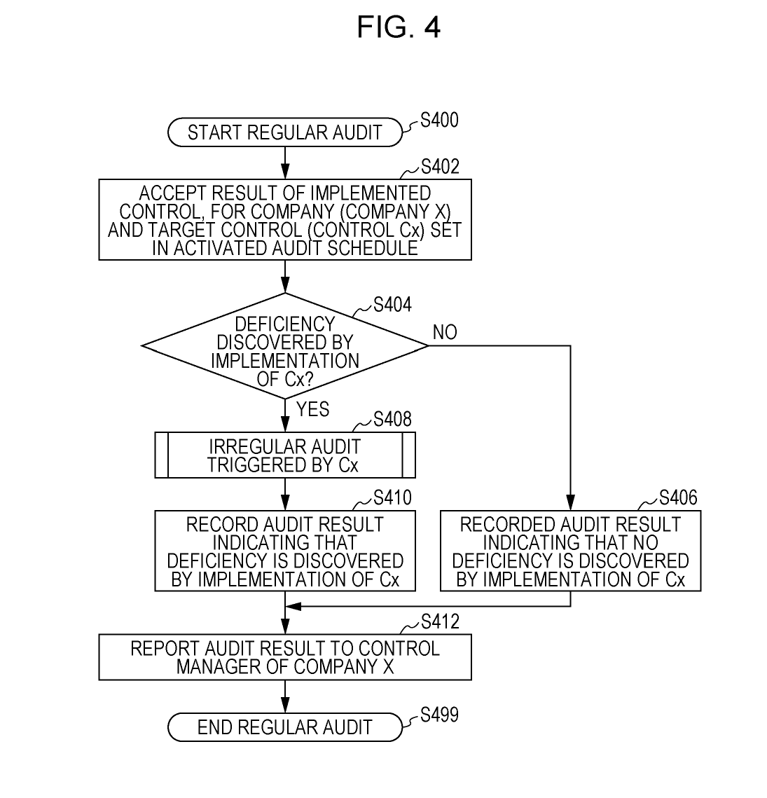

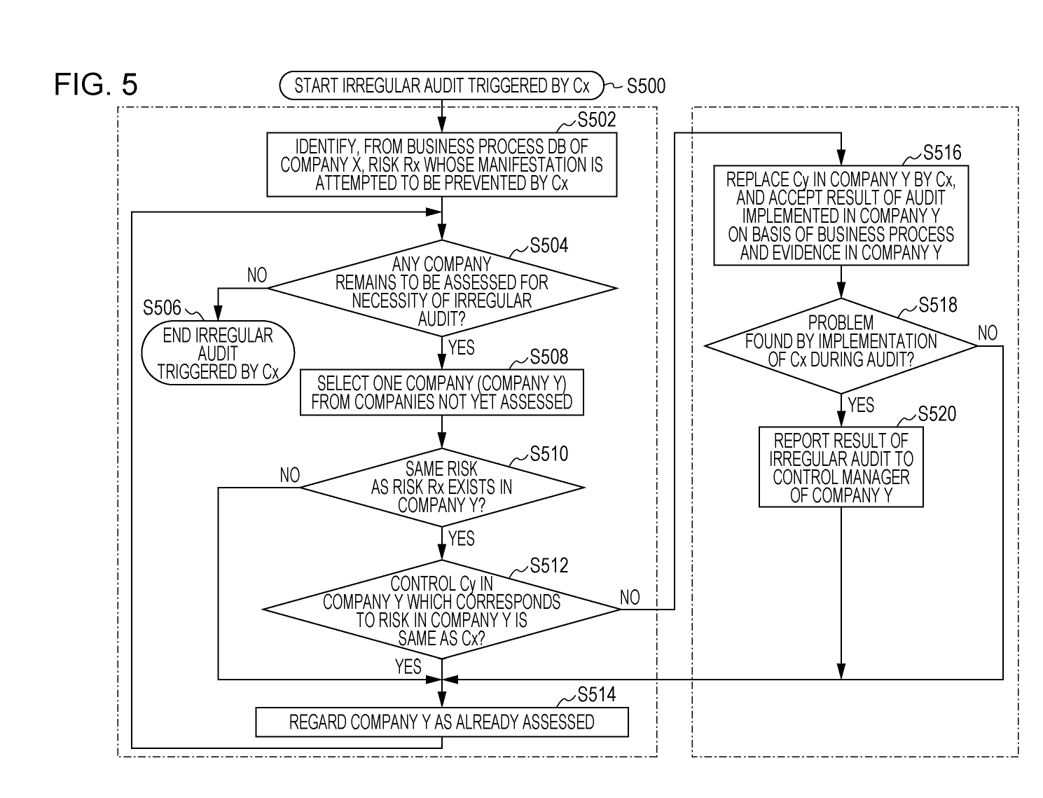

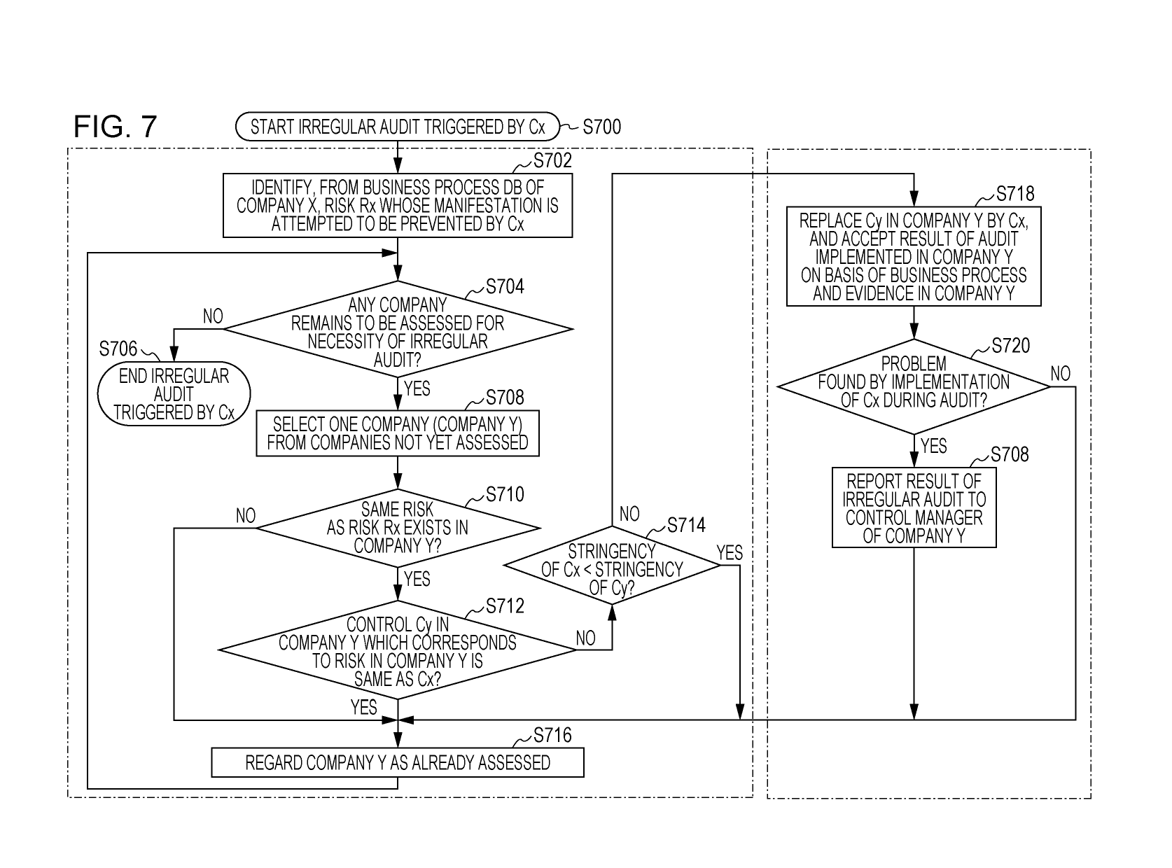

FIG. 4 is a flowchart illustrating exemplary processing according to the exemplary embodiment. The flowchart depicted in FIG. 4 illustrates processing executed when the audit schedule of a regular audit reaches the audit start date and time. The flowcharts depicted in FIGS. 5 and 7 each illustrate a sub-flow of an irregular audit (process in step S408) included in the flowchart illustrated in FIG. 4.

In step S400, a regular audit is started.

In step S402, the result of the implemented control is accepted for the company (Company X in this example) and the target control (control Cx in this example) that are set in the activated audit schedule.

In step S404, it is determined whether a deficiency is discovered by implementation of Cx. The processing proceeds to step S408 if a deficiency is discovered. Otherwise, the processing proceeds to step S406.

In step S406, an audit result indicating that no deficiency is discovered by implementation of Cx is recorded.

In step S408, an irregular audit triggered by Cx is performed.

In step S410, an audit result indicating that a deficiency is discovered by implementation of Cx is recorded.

In step S412, the audit result is reported to the control manager of Company X.

In step S499, the regular audit is ended.

FIG. 5 is a flowchart illustrating exemplary processing (exemplary processing in step S408 in the flowchart illustrated in FIG. 4) according to the exemplary embodiment.

In step S500, an irregular audit triggered by Cx is started.

In step S502, a risk Rx whose manifestation is attempted to be prevented by Cx is identified from the business process DB of Company X.

In step S504, it is determined whether any company remains to be assessed for the necessity of an irregular audit. The processing proceeds to step S508 if any such company remains. Otherwise, the processing proceeds to step S506.

In step S506, an irregular audit triggered by Cx is ended.

In step S508, one company (Company Y in this example) is selected from companies that have not been assessed yet.

In step S510, it is determined whether the same risk as the risk Rx exists in Company Y. The processing proceeds to step S512 if the same risk exists. Otherwise, the processing proceeds to step S514.

In step S512, it is determined whether a control Cy in Company Y which corresponds to the risk in Company Y is the same as Cx. The processing proceeds to step S514 if the control is the same. Otherwise, the processing proceeds to step S516.

In step S514, Company Y is regarded as having been already assessed.

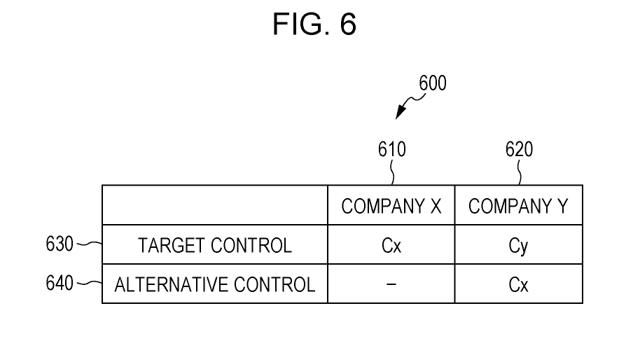

In step S516, Cy in Company Y is replaced by Cx, and the result of an audit implemented in Company Y on the basis of a business process and evidence in Company Y is accepted. For example, a regular audit and an irregular audit may be selectively used by using a target control/alternative control correspondence table 600. FIG. 6 illustrates an exemplary data structure of the target control/alternative control correspondence table 600. The target control/alternative control correspondence table 600 has a Company X field 610 and a Company Y field 620 in the column-wise direction, and a Target Control field 630 (which indicates each control implemented in a regular audit and corresponding to the same risk) and an Alternative Control field 640 (which includes a control implemented in an irregular audit) in the row-wise direction. The Company X field 610 in the column-wise direction indicates a control in Company X (a company in which a deficiency is discovered by a regular audit). Accordingly, no alternative control is necessary. The Company Y field 620 in the column-wise direction indicates a control in Company Y (a company for which an irregular audit is to be performed). The control implemented in Company Y in a regular audit is Cy. Since Cx and Cy correspond to the same risk, these controls are regarded as target controls in relation to each other (see the Target Control field 630). Accordingly, in Company Y for which an irregular audit is to be performed, Cx is implemented as an alternative control to Cy.

In step S518, it is determined whether a problem is found by implementation of Cx during the audit. The processing proceeds to step S520 if a problem is found. Otherwise, the processing proceeds to step S514.

In step S520, the result of the irregular audit is reported to the control manager of Company Y.

The processes in steps S502 to S514 relate to determination of an irregular audit target. Further, the processes in steps S516 to S520 relate to implementation of an irregular audit.

FIG. 7 is a flowchart illustrating exemplary processing (exemplary processing in step S408 in the flowchart illustrated in FIG. 4) according to the exemplary embodiment.

In step S700, an irregular audit triggered by Cx is started.

In step S702, a risk Rx whose manifestation is attempted to be prevented by Cx is identified from the business process DB of Company X.

In step S704, it is determined whether any company remains to be assessed for the necessity of an irregular audit. The processing proceeds to step S708 if any such company remains. Otherwise, the processing proceeds to step S706.

In step S706, an irregular audit triggered by Cx is ended.

In step S708, one company (Company Y in this example) is selected from companies that have not been assessed yet.

In step S710, it is determined whether the same risk as the risk Rx exists in Company Y. The processing proceeds to step S712 if the same risk exists. Otherwise, the processing proceeds to step S716.

In step S712, it is determined whether a control Cy in Company Y which corresponds to the risk in Company Y is the same as Cx. The processing proceeds to step S716 if the control is the same. Otherwise, the processing proceeds to step S714.

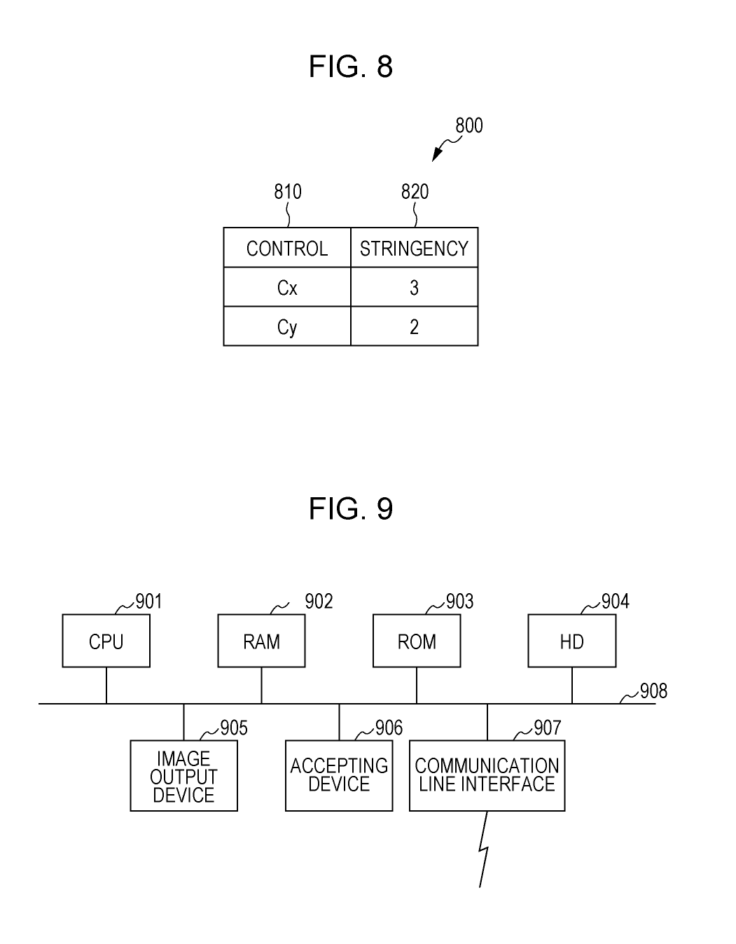

In step S714, it is determined whether “stringency of Cx<stringency of Cy.” If “stringency of Cx<stringency of Cy”, the processing proceeds to step S716. Otherwise, the processing proceeds to step S718. The stringency of a control may be identified by using a control/stringency correspondence table 800. An irregular audit is not implemented for an organization that is implementing a similar, more stringent control at the point in time when a deficiency is discovered, thus avoiding an unnecessary increase in audit cost. FIG. 8 illustrates an exemplary data structure of the control/stringency correspondence table 800. The control/stringency correspondence table 800 has a Control field 810, and a Stringency field 820. The Control field 810 stores a control. The Stringency field 820 stores the stringency of the control. For example, a larger numerical value indicates a higher level of stringency. Of course, this relationship may be opposite (the higher the ordinal rank (the smaller the numerical value), the higher the level of stringency). In the example illustrated in FIG. 8, the stringency of Cx is 3, and the stringency of Cy is 2, indicating that Cx us more stringent than Cy. The stringency of each control may be defined by the inclusion relationship between controls. For example, if Control A includes Control B, this indicates that Control B is more stringent than Control A.

In step S716, Company Y is regarded as having been already assessed.

In step S718, Cy in Company Y is replaced by Cx, and the result of an audit implemented in Company Y on the basis of a business process and evidence in Company Y is accepted.

In step S720, it is determined whether a problem is found by implementation of Cx in the audit. The processing proceeds to step S722 if a problem is found. Otherwise, the processing proceeds to step S716.

In step S722, the result of the irregular audit is reported to the control manager of Company Y.

The processes in steps S702 to S716 relate to determination of an irregular audit target. Further, the processes in steps S718 to S722 relate to implementation of an irregular audit.

If a second organization is unable to implement a control implemented in a first organization, notification of a description of the control may be provided. Specifically, if, in a company or organization for which an irregular audit is determined to be necessary, it is not possible to automatically apply the control in question by the audit implementation module 120, the control manager of the target company or organization may be given a notification advising the control manager to apply the control. A more specific example will be described in (Case derived from Case 1) below. As a result, even in cases where it is not possible to immediately perform an irregular audit, a problem is made known to the control manager, giving the control manager a change to review a relevant control.

Specific cases will be described below.

(Case 1)

Individual companies adopt the following controls over the risk of occurrence of illicit transactions.
Company A: Check the history of the date and time of sending and date and time of receipt of transaction slips

This control is implemented by a script that automatically checks the order relation between time data entries made in the date and time entry field and the presence of “future date and time.”
Company B and Company C: Check for an approval seal on transaction slips

This control is implemented by a script that recognizes the image of a seal impression on a slip.

The following process is performed.

(1) A slip with a problem in history data is discovered in Company A.

(2) The auditing cloud service 200 is notified of the company ID of Company A, and the control by which the problem is found.

(3) Because Company B and Company C use a different control over the same risk, it is determined to perform an irregular audit for both companies.

(4) A script for executing an audit method used in Company A is generated, and sent to Company B and Company C.

(5) In each of Company B and Company C, the script sent to the company in (4) is executed, and the control manager of each of Company B and Company C is notified of the execution result.

(Case Derived from Case 1)

The controls adopted by individual companies are the same as those in Case 1. The following describes a case where although a problem is found by implementation of a control in Company B, the Company A's system does have an image recognition function. For example, this corresponds to a case where a scanner is necessary for the image recognition function but Company A does not have such a scanner.

The following process is performed.

(1) A slip with no approval seal is discovered.

(2) The auditing cloud service 200 is notified of the company ID of Company B, and the control by which the problem is found.

(3) Because Company A uses a different control over the same risk, it is determined to perform an irregular audit for Company A.

(4) A script for executing an audit method used in Company B is generated, and sent to Company A.

(5) Because it is not possible to execute the script in Company A, the control manager of Company A is given a notification of a description of the control to be implemented, advising the control manager to manually execute the control.

(Case 2)

With regard to workplace safety and hygiene, individual companies adopt the following controls over the risk of occurrence of Disaster X.
Company A and Company B: Periodically distribute a checklist to the members of the workplace, and check answer data

This control is executed by a script that automatically checks for the presence of a “Not OK” (Unacceptable) answer.
Company C: Periodically check an increase in the number of registered near-miss cases related to Disaster X

This control is implemented by a script that automatically checks if the number of cases that has increased is below a predetermined number.

The following process is performed.

(1) A “Not OK” answer is checked in Company A.

(2) The auditing cloud service 200 is notified of the company ID of Company A, and the control by which the problem is found.

(3) Because Company C uses a different control over the same risk, it is determined to perform an irregular audit for Company C.

(4) The definitions of checklist items and members to whom to distribute the checklist are sent to Company C, and Company C is instructed to perform an irregular audit.

(5) The checklist is distributed in Company C, and the control manager of Company C is notified of the answers to the checklist.

(Case Derived from Case 2)

The controls adopted by individual companies are the same as those in Case 2. The necessity of an irregular audit for a similar control is determined in accordance with the stringency of implementation of the control.
In Company A, additional comments are entered for each item that is answered “Not OK”.
In Company B, regardless of whether an answer is “OK” or “Not OK”, a person responsible for answering the checklist takes and attaches a photograph that serves as proof, and another member of the workplace adds a signature to the photograph which certifies the photographed area and the date and time of photography.
The auditing cloud service 200 holds associated information indicating that “Company A<Company B” with regard to the stringency of implementation of the control.

In this case, the following process is performed.
If a “Not OK” answer is checked in Company A, an irregular audit is not implemented in Company B.
If a “Not OK” answer is checked in Company B, an irregular audit is implemented in Company A. At this time, the same method as used in Company B is continued for a predetermined period of time.

The hardware configuration of a computer on which the program according to the exemplary embodiment is executed is that of a general computer as illustrated in FIG. 9, specifically, a computer or the like that may serve as a personal computer or a server. That is, as a specific example, a CPU 901 is used as a processing unit (arithmetic unit), and a RAM 902, a ROM 903, and a HD 904 are used as memories. For example, a hard disk or a solid state drive (SSD) may be used as the HD 904. The computer is made up of: the CPU 901 that executes a program for implementing modules such as the irregular-audit-target determination module 115, the audit implementation module 120, the audit result reporting module 125, the audit method management module 130, and the audit schedule management module 135; the RAM 902 that stores the program and data; the ROM 903 in which a program for booting the computer, and the like are stored; the HD 904 that serves as an auxiliary memory (which may be a flash memory or the like); an accepting device 906 that accepts data on the basis of a user's operation with a keyboard, a mouse, a touch panel, or the like; an image output device 905 such as a CRT or a liquid crystal display; a communication line interface 907 for establishing a connection with a communication network, such as a network interface card; and a bus 908 that interconnects the above-mentioned components to exchange data. Multiple such computers may be connected to each another via a network.

For features based on a computer program in the foregoing exemplary embodiments, a system having the above-mentioned hardware configuration is caused to read the computer program as software, and as the software cooperates with hardware resources, the above-mentioned exemplary embodiment is implemented.

The hardware configuration depicted in FIG. 9 is only illustrative. The exemplary embodiment is not limited to the configuration illustrated in FIG. 9 as long as the modules described in the exemplary embodiment may be executed. For example, some modules may be implemented by dedicated hardware (such as an application-specific integrated circuit (ASIC)), and some modules may be provided within an external system and may be connected via a communication line. Further, multiple systems configured as illustrated in FIG. 9 may be connected to each another by a communication line so as to operate in cooperation with each other. Further, other than personal computers, the above configuration may be incorporated in, in particular, information home appliances, copiers, facsimiles, scanners, printers, multifunction machines (image processing devices having two or more of, for example, scanner, printer, copier, and facsimile functions).

When an irregular audit is to be implemented, the control to be applied on an irregular basis, and the control usually applied in the organization of interest may be applied for a given specific period of time. Then, the audit results from the two cases are compared and reported to the control manager (in particular, the control manager in the second organization). If the comparison reveals a noticeable difference, the report may include information advising replacement by the control used in the irregular audit or combined use of both controls. That is, the control manager is provided with information that allows the control manager to judge which control is more appropriate as the control to be applied from now on.

The program described herein may be provided in the form of being stored in a recording medium, or the program may be provided via a communication unit. In that case, for example, the above-mentioned program may be understood as an invention relating to a “computer readable recording medium recording a program.”

The “computer readable recording medium recording a program” refers to a computer readable recording medium on which a program is recorded and which is used for purposes such as installing, executing, and distributing the program.

Examples of the recording medium include digital versatile discs (DVDs), such as “DVD-R, DVD-RW, DVD-RAM, and the like”, which are standards developed by the DVD Forum, and “DVD+R, DVD+RW, and the like”, which are standards developed by the DVD Forum, compact discs (CDs) such as read-only memory (CD-ROM), CD-Recordable (CD-R), and CD-Rewritable (CD-RW) discs, Blu-ray (registered trademark) discs, magneto-optical disks (MOs), flexible disks (FDs), magnetic tapes, hard disks, read-only memories (ROMs), electrically erasable programmable read-only memories (EEPROMs (registered trademark)), flash memories, random access memories (RAMs), and Secure Digital (SD) memory cards.

The above-mentioned program or a portion thereof may be recorded on the above-mentioned recording medium for purposes such as saving and distribution. Alternatively, the program may be transmitted via a transmission medium such as a wired network or a wireless communication network which is used for a local area network (LAN), a metropolitan area network (MAN), a wide area network (WAN), the Internet, an intranet, an extranet, and the like, or a combination thereof, or may be carried on a carrier wave.

Further, the program mentioned above may be part of another program, or may be recorded on a recording medium together with a different program. Alternatively, the program may be recorded separately on multiple recording media. Furthermore, the program may be recorded in any form, such as compressed or encrypted, as long as the program may be restored.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
an instructing unit that, if a deficiency in a first organization is discovered by implementation of a control in the first organization, instructs a second organization to implement the control implemented in the first organization, the second organization having a risk equivalent to a risk corresponding to the control and adopting a control that is not equivalent to the control.

2. The information processing apparatus according to claim 1, wherein if the control implemented in the first organization is more stringent than the control adopted by the second organization, the instructing unit instructs the second organization to implement the control implemented in the first organization.

3. The information processing apparatus according to claim 1, further comprising:
a notifying unit that, if the second organization is unable to execute the control implemented in the first organization, provides notification of a description of the control.

4. The information processing apparatus according to claim 2, further comprising:
a notifying unit that, if the second organization is unable to execute the control implemented in the first organization, provides notification of a description of the control.

5. The information processing apparatus according to claim 1, further comprising:
a disclosing unit that discloses the control implemented in the first organization to at least an organization other than the first organization.

6. The information processing apparatus according to claim 1, further comprising:
a reporting unit that reports a comparison result, the comparison result being a result of comparison between a case in which the second organization is caused to implement the control implemented in the first organization and a case in which the second organization is caused to implement the control adopted by the second organization as usual.

7. A non-transitory computer readable medium storing a program causing a computer to execute a process for processing information, the process comprising:
instructing, if a deficiency in a first organization is discovered by implementation of a control in the first organization, a second organization to implement the control implemented in the first organization, the second organization having a risk equivalent to a risk corresponding to the control and adopting a control that is not equivalent to the control.

8. An information processing method comprising:
instructing, if a deficiency in a first organization is discovered by implementation of a control in the first organization, a second organization to implement the control implemented in the first organization, the second organization having a risk equivalent to a risk corresponding to the control and adopting a control that is not equivalent to the control.
